(19) United States
(12) Patent Application Publication
(10) Pub. No.: US 2025/0180735 A1
(43) Pub. Date: Jun. 5, 2025

(54) ADAPTIVE SYSTEM BASED ON ULTRA-WIDE BAND FOR THE DYNAMIC DETECTION OF POSSIBLE COLLISIONS

(71) Applicants: Claudio SALVADOR, Scandicci (IT); Filippo BONIFACIO, Firenze (IT)

(72) Inventors: Claudio SALVADOR, Scandicci (IT); Filippo BONIFACIO, Firenze (IT)

(21) Appl. No.: 18/868,658

(22) PCT Filed: May 29, 2023
(86) PCT No.: PCT/IB2023/055487

§ 371 Date: Nov. 22, 2024

(30) Foreign Application Priority Data
May 30, 2022 (IT) 102022000011396

(51) Int. Cl. G01S 13/93; G01S 13/02; G01S 13/06; G01S 13/87

(52) U.S. Cl. CPC G01S 13/93; G01S 13/0209; G01S 13/06; G01S 13/878

(57) ABSTRACT

An adaptive system for the dynamic detection of possible collisions between fixed objects, moving objects, and operators within a predetermined area of interest, based on a single sensor in UWB (Ultra-Wide Band) technology adapted to detect the position of a TAG within its area of action by exploiting the determination of the angle of arrival and a distance measurement. The system is further configured to operate correctly with TAGs which are at a height equal or near the height of the sensor itself.

### FIELD OF THE INVENTION

The present invention relates to the field of devices for detecting people or things in areas of interest. In particular, the present invention relates to the field of devices for implementing active safety functions and reducing the risk of possible accidents, e.g., such as those occurring following collisions between people and machinery, between mobile vehicles and people, and between different vehicles, in industrial and construction site environments.

### BACKGROUND ART

Radiofrequency systems have been successfully used in recent years for proximity detection between people and fixed or mobile machinery to prevent possible collisions and possibly condition the behavior of the machinery or vehicle in order to increase safety margins. Indeed, it is possible to slow down the movement of a vehicle and stop the operations of a machine when the presence of an operator is detected within a given predefined proximity area.

In the most common cases, detection systems of this type are installed on fixed or mobile machinery or vehicles, and the corresponding detected devices, the so-called TAGs, are worn by operators within the monitored area. In other cases, the TAGs are positioned on the machinery or vehicles placed within the monitored area to detect possible collisions between vehicles or between vehicles and fixed machinery.

In recent years, there has been widespread use of techniques through which the operator or the vehicle equipped with a TAG, is detected entering the safety area around the machinery on which the detection system is installed by measuring its distance from the machinery and/or its position.

The development of this approach is mainly due to the use of Ultra-Wide Band (UWB) technology, which makes it possible to determine the distance and position of a transceiver with errors in the order of centimeters, an accuracy unattainable with many other types of techniques.

A simple ranging or distance measurement is achieved with this technique, in its simplest application. This allows for proximity areas that are necessarily spherical.

If the system on board the machinery has at least three devices each capable of measuring the distance to the nearby portable transceiver, by virtue of the so-called trilateration technique, it will be possible to determine the exact position of the portable transceiver relative to the reference system of the machinery.

It is apparent that knowing the location, as well as simple presence, allows for significantly more advanced functions, e.g., such as defining alarm or proximity areas which can have a completely arbitrary shape in theory.

In more detail, a UWB system exploits pulses of very short duration to determine the time of flight between two transceiver devices. The transceiver devices in connection exchange a series of messages with each other and, by exploiting special algorithms, can accurately determine the time of flight. Knowing the time of flight makes it possible to know the distance between these devices.

Having three such transceiver devices, so-called anchors, placed on fixed or mobile machinery and adapted to dialog, each independently, with a fourth transceiver device, TAG, it would be possible to know the distances of each of the three devices from the fourth device. Then by performing trilateration, it will be possible to calculate the position of the TAG in the reference system of the fixed or mobile machinery.

If the measurements of the aforesaid distances were accurate, solving a system in three equations and three unknowns would be sufficient to determine the location of the TAG. This solution is geometrically corresponding to determining the point of intersection of three spheres having a radius equal to each of the three measured distances. However, since the measurements are not exact, it is necessary to apply correction algorithms, which allow the system of three equations and three unknowns to be solved even in the real case in which the aforesaid intersection of the spheres is not exactly punctual.

The above-described method has several drawbacks.

First, at least 3 anchors that must be connected and coordinated with each other are needed. The results of the measurements must then be processed by a central computer. This results in an architecture with many components, which is not easy to install. Furthermore, although the accuracy of UWB systems for distance measurement is very good, the configuration of anchors can heavily bias the positioning error. Indeed, it is also possible to demonstrate that the errors in measuring position can be much greater than those in measuring distance if the anchors are very close to each other. Regretfully, this case occurs very often because if the three anchors are placed on a piece of machinery, e.g., such as a forklift or a self-driving vehicle, it is virtually certain that the TAG is located far outside the polygon described by the anchors, and this is a problem that should not be neglected in the calculations to be performed.

Furthermore, the three anchors measure the distance at different times, so the TAG position is calculated with three data points that are not, strictly speaking, temporally consistent. There are techniques to minimize the delay time between the instants of taking the three measurements but it cannot be eliminated. If the relative TAG-system motion is rapid, this may be reflected in dummy oscillations of the position detection.

Finally, it is worth noting that the employed radio channel occupancy is quite large because each anchor must exchange multiple messages with the TAG and each machine must be equipped with at least three anchors. Considering the entirely realistic case that multiple operators and multiple mobile machines may engage in the same monitored area, it is apparent that the risk of radio message collisions may be non-negligible. This drawback must also be given due consideration because UWB signals are not particularly robust relative to collisions, and the risk of fallacious measurements is therefore high.

Another commonly used technique enables the detection of the angle of arrival. This technique makes it possible to overcome some of the drawbacks described earlier by allowing a single transceiver to know the distance and direction of the link signal to a TAG. This detection technique of the angle of arrival (AoA) has been known for many years and allows the spatial direction of a radio frequency signal transmitter to be defined relative to a receiver. This technique uses a multiplicity of antennas on the receiver to measure the electrical phase differences of the signals received on each one, and based on these differences, through special computational algorithms, the geometric angle at which the signal arrives on the receiver itself is calculated. Although this technique has been known for a long time and has been successfully used in a wide range of fields, from radar to mobile telephony, it has also seen increasing use in recent years for detecting the location of objects or people (so-called asset/people tracking) in a given space by employing low-power radio technologies that are easy to integrate. Indeed, in many cases, it is possible to apply the AoA technique to signals used to transmit other information, by measuring the arrival electrical phases of messages of various types and formatted according to widely used standards, without the phase measurement made making it necessary to modify the message itself or to lose compatibility with the standard employed. This is a considerable advantage because it allows the function of measurement of the angle of arrival to be added by changing only the receiver and keeping the transmitter in a simple, standard configuration.

In the scope of asset and people tracking, the AoA technique is used, for example, in conjunction with Ultra-Wide Band radio channels. In this case, the addition of the angle of arrival information makes both the distance to be detected and the direction, available to a single receiver, and thus the receiver can estimate a position in space.

This makes the AoA technique extraordinarily attractive to the point that the telephony world is moving to integrate it into smartphone devices. Measurement of the relative electrical phase of various signals received on multiple antennas can now be accomplished with dedicated chipsets available in the prior art using both UWB and Bluetooth technology.

The antennas used with these techniques are almost all of the so-called patch type. This type of antenna is easy to implement because, at working frequencies, it can be made on printed circuit boards (PCBs), but it has a radiation pattern limited to one half-space being made on a ground plane. In addition to this, again due to the presence of the background plane, there is a radiation null for angles relative to the z-axis equal to 90 degrees. Furthermore, for angles relative to the z-axis close to 90 degrees, the interference between the various antennas in the receiver group becomes particularly major, making the measured electrical angle completely unusable. All these aspects mean that the coverage angle of these systems can never exceed 75 to 80 degrees from the normal. As a result, this type of antenna systems allows for optimal performance as the target to be detected is prevalently in the space located in front of the antennas and, therefore, they are typically installed in a vertical position, such as on a wall or ceiling, and always have the limitation that the distance of the target from the height must not be such that it results in a too high angle with respect to z-axis.

Installing a single UWB system also equipped with the phase measurement feature on a mobile machine would, in theory, also allow the positions of target objects placed near the transceiver to be detected with an angular coverage of 360°, but patch-type antennas could not be used because, as the heights of the targets are comparable to that of the sensor, it would fall under the conditions in which this antenna does not work properly.

Finally, on a mobile vehicle, a plurality of receiving systems could be used each equipped with its own set of antennas, and arranged, for example, on the perimeter of the fixed or mobile machinery and differentially oriented could not benefit from the many advantages of knowing the angle of arrival. The system would be considerably complicated both in terms of hardware and the necessary electrical communications, being in fact similar to the systems used for the position calculation technique by means of trilateration.

Thus, thresholds or static detection areas are used in the current state of the art concerning detection systems for fixed or moving machinery, and in the case of moving machinery, there is no possibility of adapting its motion relative to the subjects or objects being detected. This is a major limitation because the risk of possible interference between people and fixed or moving machinery depends not only on relative position but also on relative motion. Indeed, an operator who is in the trajectory of motion of a moving vehicle which is moving at a sustained speed toward the operator may result in a higher risk situation even if the operator is at a much greater distance than an operator who is close to a moving vehicle but with zero relative motion or mutual separating motion.

Furthermore, the currently available systems do not allow for objective measurements of the collision risk factor present in a given area. Indeed, the known collision avoidance assistance systems take detections that may, eventually, be stored but are never processed to achieve an overall assessment of the risk factor characteristic of the area of interest.

The availability of an objective parameter for assessing an event based on the associated collision risk within an area of interest of a plant or construction site could allow an objective estimate to be given of the real hazard in the area of interest, thus allowing variations in operations, within the area of interest, to be implemented such that the actual risk of hazardous interference between potential colliders is reduced, effectively and while maintaining overall productivity.

Therefore, the availability of an objective parameter for assessing the risk of collision within an area of interest would enable the safety manager of a facility or construction site to continuously monitor the actual risk in the various areas of the facility or construction site to intervene in a timely manner only in the areas in which the risk is actually greatest thereby also being able to preserve overall efficiency.

A collision avoidance system, and related method, which operates the determination of the motion and position of objects and operators in an area of interest, overcoming the drawbacks and shortcomings of the prior art listed above, would be a significant improvement in safety and accident prevention with particular regard to the industrial and shipbuilding environment.

### SUMMARY OF THE INVENTION

The present invention relates to an adaptive system and method thereof for the dynamic detection of possible collisions between fixed objects, moving objects, and operators within a predetermined area of interest, based on a single sensor in Ultra-Wide Band (UWB) technology adapted to detect the position of a TAG within its area of action by exploiting the angle of arrival (AoA) technique in conjunction with distance measurement. Said single sensor is made in such a way that it can also operate properly against TAGs that are at a height equal or near the height of the sensor itself. This is accomplished by virtue of the use of a plurality of antennas for UWB signals such that the limitation of the detection angle relative to the z-axis is overcome.

Furthermore, the present invention provides a criterion for conversion from electrical angles to angles of arrival which considers the specificity of the antennas made by effectively compensating for their possible distortions and introducing filtering techniques of the received signal which make it possible to correctly evaluate the relative motion between the sensor and the TAG.

Finally, the present invention provides a method for calculating the risk function of a single detection and for determining, starting from a plurality of detections, a single most significant interaction event with which a unique risk function is associated.

### BRIEF DESCRIPTION OF THE FIGURES

Further features and advantages of the invention will become apparent from reading the following detailed description, given by way of a non-limiting example, with the aid of the figures shown in the accompanying drawings, in which:

FIG. 1 shows an application example of the invention in which a sensor and TAG are associated with moving objects in the same plane, in particular, a forklift and an operator on foot;

FIG. 2 shows a functional block diagram of the hardware structure of the sensor and TAG system according to the present invention;

FIG. 3 shows a diagram of a preferred embodiment of the antennas according to the present invention;

FIG. 4 shows the trend of the differences Δ₁, Δ₂ and Δ₃, normalized relative to the side I of the triangle with the antennas A1, A2, and A3 at the vertices, as the angle of arrival α changes;

FIG. 5 shows a preferred embodiment of the trio of antennas A1, A2, and A3 by means of biconical antennas interspersed with non-conductive and radio-transparent materials, and

FIG. 6 shows a preferred embodiment of the trio of antennas A1, A2, and A3 by means of mono-conical antennas mounted on a circular ground plane.

The following description of exemplary embodiments relates to the accompanying drawings. The same reference numbers in the various drawings identify the same elements or similar elements. The following detailed description does not limit the invention. The scope of the invention is defined by the appended claims.

### DETAILED DESCRIPTION OF THE INVENTION

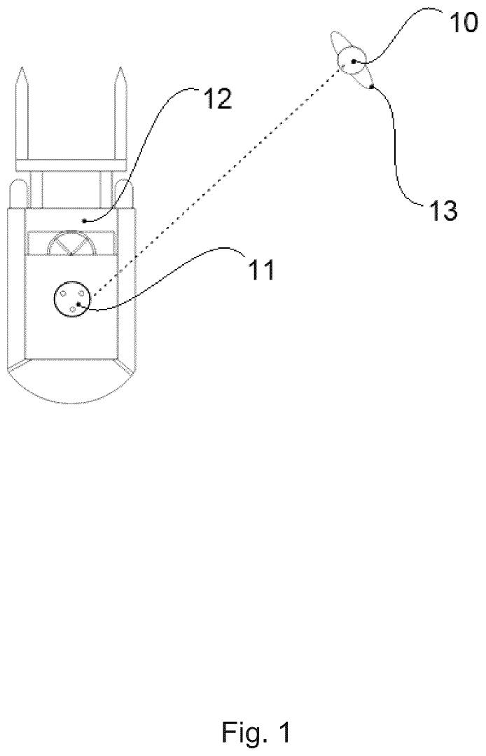

Accompanying FIG. 1 shows the case in which a first transceiver, or TAG, 10, and a second transceiver, or sensor, 11, e.g., operating in the frequency range of 2 GHz to 10 GHz, are associated with mutually moving objects.

For example, in an industrial area, said second transceivers/sensors 11 may be associated with forklifts 12 operating in the area, and said first transceivers/TAGs 10 may be associated with the operators 13 who are moving on foot or by other vehicles.

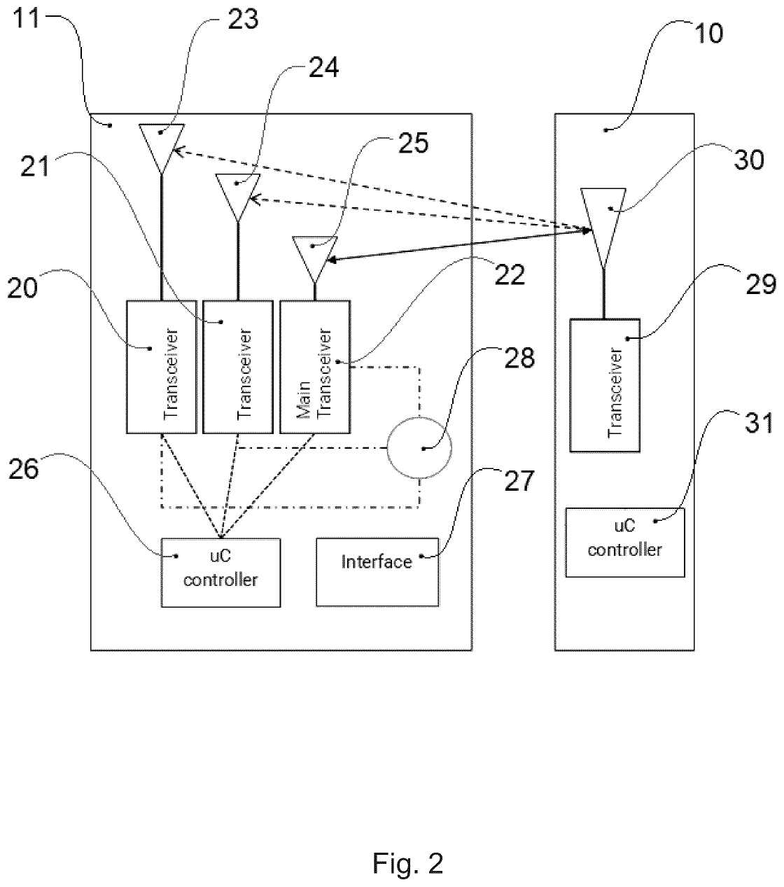

With reference to the accompanying FIG. 2, in a preferred embodiment of the invention, said sensor 11 comprises at least three transceivers 20, 21, 22 each associated with an antenna 23, 24, 25. Said transceivers are connected to a control unit 26, configured to appropriately drive said transceivers and to manage at least one possible external interface 27, which may be an interface for connecting to external systems, e.g., such as the machinery on which said sensor 11 is installed, or a user interface for displaying and configuring the operating parameters of said sensor 11. The control unit 26 can advantageously comprise a microcontroller and an associated memory unit adapted to contain program instructions and data.

In particular, said control unit 26 is adapted to regulate the transmission and reception sequences and to process the signals transmitted and received by said TAG 10 in an appropriate manner to calculate its distance and velocity relative to said sensor 11. Furthermore, the transceivers are preferably coherent, i.e., they are connected to the same clock source 28.

In a preferred embodiment of the invention, said transceivers 20, 21, 22 are configured so that one of said transceivers is the main transceiver, adapted to determine the distance to said TAG 10 while the other two are adapted to measure the relative phase with respect to said main transceiver.

Said TAG 10 comprises at least one transceiver 29, an antenna 30, and a controller 31 configured to appropriately drive said transceiver 29 to manage the transmission and reception sequences, in particular to said sensor 11. Preferably, said TAG 10 further comprises a power battery so that it can be worn even by an operator not associated with a vehicle.

During the operation of the system according to the invention, said sensor 11 performs a transceiver exchange with said TAG to determine the distance between the sensor 11 and the TAG 10 employing known techniques, such as based on Ultra-Wide Band signals. Then, using the information connected with the signals received from the TAG, the sensor operates to measure the electrical phase of said signals received from the TAG and calculate the difference between the measured phases and, based on this difference, the geometric angle of arrival of the signal transmitted by TAG 10 and then the direction and geometric angle of approach of TAG 10 to sensor 11.

The known techniques for establishing the time-of-flight of an electromagnetic signal and thus the distance between a transmitter and a receiver include RTT (Round Trip Time)—based on a double transmission, first in one direction and then in the other—or TWR (Two Way Ranging) techniques, which take advantage of more transmissions between the two transceivers to allow greater immunity to some typical drifts in the electronics employed, e.g., such as deviation of the frequency references of the two transceivers.

In the present invention, said sensor 11 exploits one of the receiving radio exchanges to also determine the geometric angle of arrival of the signal transmitted by the TAG, by virtue of the use of a plurality of antennas 23, 24, 25.

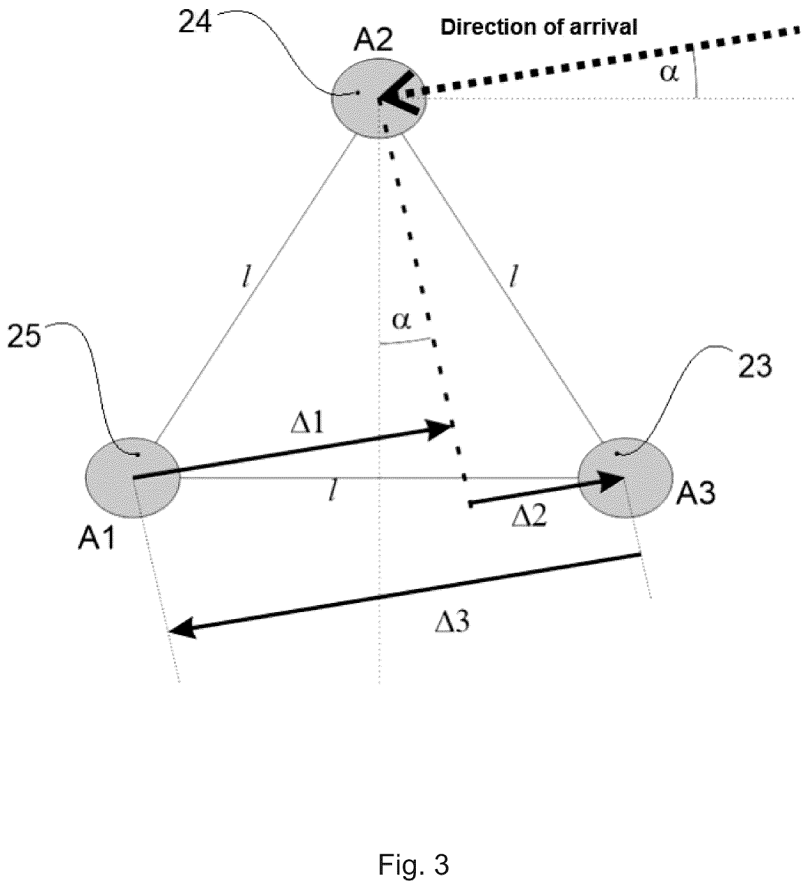

In a preferred embodiment, shown in the accompanying FIG. 3, the sensor 11 comprises a system of three antennas A1, A2, and A3 arranged at the vertices of an approximately equilateral triangle of side I. Considering this set of three antennas arranged in a Cartesian reference system with an x-axis of abscissae and a y-axis of ordinates.

The object on which the TAG is placed moves in a direction, which is inclined at an angle of arrival α to the x-axis and has a distance d from the three receiving antennas, A1, A2 and A3, much greater than I.

In this manner, the directions of arrival of the transmitter relative to each of the three receiver antennas can be considered approximately parallel to each other.

With the above approximations, the differences, Δ, between the calculated distances along the arrival directions of the transmitter device from the antennas of the receiver device are as follows:
Δ₁=I sin (α+30°) (difference between the distance of the transmitter from antenna A1 and the distance of the transmitter from antenna A2);
Δ₂=I sin (30°−α) (difference between the distance of the transmitter from antenna A2 and the distance of the transmitter from antenna A3)
Δ₃=−(Δ₁+Δ₂)=−I cos (α) (difference between the distance of the transmitter from antenna A1 and the distance of the transmitter from antenna A3).

From the calculation of two of these three distances, the third distance can be derived by virtue of simple trigonometric relations therebetween.

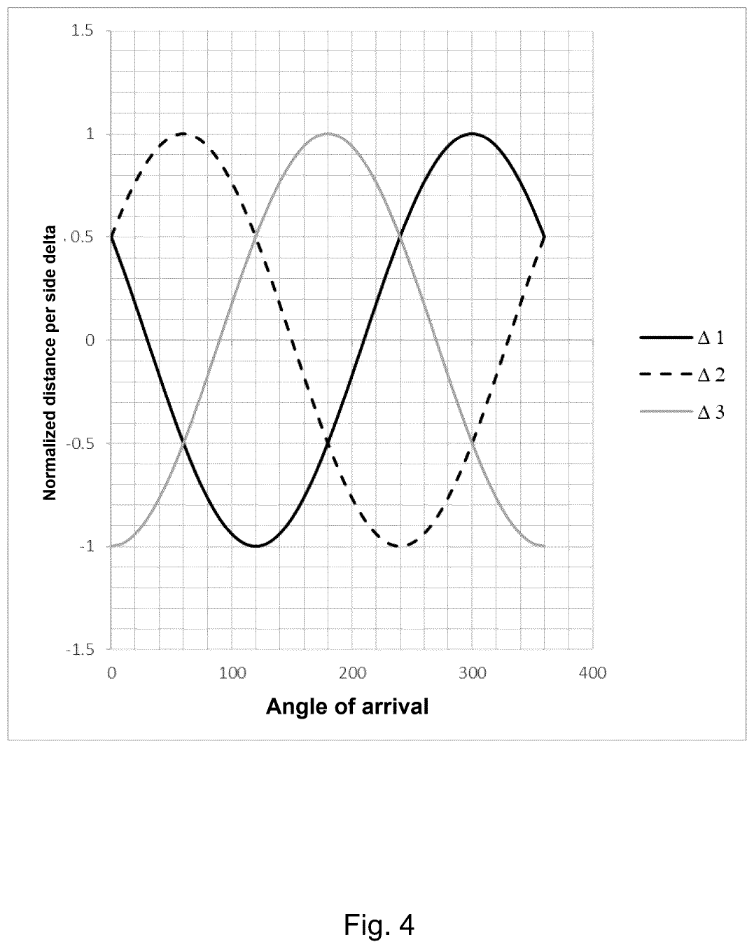

As the angle of arrival α varies, the differences Δ₁, Δ₂ and Δ₃, normalized relative to the side I of the above triangle with the receiving antennas A1, A2, and A3 at the vertices, will have a pattern as described in the graph in accompanying FIG. 4.

The path difference of the signals transmitted by the transmitter further corresponds to an electrical phase difference between the signals received by the three receiving antennas A1, A2, and A3. The electric angle or electric phase, θ, of the electromagnetic signals received by the three antennas can be expressed by the equation:

θₙ=Δₙ2π/λ

wherein λ is the wavelength of the received electromagnetic signal. From this relationship, it is derived that a convenient way to position receiving antennas is such that the size of the side of the triangle having the three antennas at the vertices is less than or equal to half the wavelength of the electromagnetic signal so that the phase difference between the received signals is always within one round angle.

So, if

I=λ/2

and

−π≤θₙ≤π

it is possible to connect the electrical phase of the signals received by the receivers to the angle of arrival α of the signals themselves. Indeed, it is possible to calculate, for each of the relative electric angles, the corresponding difference in the path taken by the signal transmitted by the transmitter:

Δₙ=θₙλ/2π

and then

$$α = arcos ( - {θ}_{3} λ / 2 π I )$$

$$α = 30 ° - arcsin ( {θ}_{2} λ / 2 π I )$$

$$α = arcsin ( {θ}_{1} λ / 2 π I ) - 30 ° .$$

As known from trigonometry, the possible solutions, for α, are 2 within a 360° angle for each of the above equations. Then using at least two of the preceding equations it is possible to determine the sought angle, α.

This calculation mode, which is very simple from a theoretical point of view, has problems related to undesirable interference effects between the three antennas A1, A2, and A3.

Indeed, in the real case, the mutual proximity of the antennas interferes with the received signal and, for some angles of arrival, causes direct interference applied by each antenna on the path of the signal directed to the other antennas. In the antenna system, A1, A2, A3, described the interference of each antenna on the others is practically always present. For example, such interference can be the cause of an increase in the phase delay of the signal directed to one antenna if this antenna is obscured by another antenna. In this case, when the electrical phase delay exceeds 180°, there is an antenna that is on a longer signal travel path—and, therefore, must have an electrical phase delay—resulting, instead, in an advance, making the data connected to the electrical phase impossible to interpret correctly. To solve this, a reduction is made in the side of the triangle at whose vertices the antennas are located, that is, the distance between the three antennas, A1, A2, and A3, is reduced. In this manner, any phase losses due to interference, while not eliminated entirely, become such that they cannot lead to misinterpretations of the phase sign. Therefore, it is required that the distance between the antennas, I, be such that:

I<λ/2.

In a preferred embodiment of the sensor 11 which employs ground plane mono-conical or biconical antennas, the distance I is preferably chosen between λ/2 and λ/4. In particular, by choosing the distance I equal to about 80% of λ/2 (or equal to 2λ/5), the uniqueness of the relationship between electric phases and corresponding geometric angles can be guaranteed.

Despite the above corrections, the electrical phase data, e are still different from those theoretically predicted. Indeed, although the uniqueness of the solution has been guaranteed and the phase is limited to 180 degrees, the angles are still distorted by mutual interference between antennas. Therefore, it is necessary to compensate for these deformations of the electrical phase in a manner, which correctly resolves the angle of arrival, α, of the received signal.

One way to correct involves, for example, using a table that shows, for each angle of arrival, α, the expected electrical phase differences, θ.

An example is given below:

| Angle of arrival | θ₁ expected | θ₂ expected |
|---|---|---|
| α₁ | θ₁₁ | θ₂₁ |
| α₂ | θ₁₂ | θ₂₂ |
| α₃ | θ₁₃ | θ₂₃ |
| . . . | . . . | . . . |
| αₖ | θ₁ₖ | θ₂ₖ |

This table can be compiled experimentally, in the initial set-up phase of the system comprising the sensor and TAG, by measuring at angles of arrival of the TAG with respect to the sensor, α, that are known, the corrected electrical phase differences, θ.

In this manner, once an electric angle pair is measured:
θ₁, θ₂
   it is possible to proceed with the calculation of a cost function for each possible angle of arrival listed in the table

$${c}_{k} = {( {θ}_{2} - {θ}_{2 k} )}^{2} + {( {θ}_{1} - {θ}_{1 k} )}^{2} .$$

The index k for which we will have the lower cₖ cost will correspond to the angle of arrival, αₖ, having maximum likelihood.

The position datum in the plane—obtained from the pair formed by the distance d detected, for example, by means of a UWB system and the angle of arrival, α, calculated as described above—when reported in polar coordinates on the plane, has different errors relative to the two coordinates, because these coordinates are calculated by different techniques.

Indeed, the distance is calculated, for example, as mentioned, with UWB technology based on time-of-flight measurement and is affected by an error expressible in absolute length terms.

Angle measurements, on the other hand, have an error, which, of course, can be expressed in terms of angle amplitude instead of distance and is quantitatively different from the error which afflicts the distance measurement because the phase difference on the trio of receiving antennas, A1, A2, and A3 is measured to estimate the angle of arrival instead of the time of flight from the transmitter.

While the position error due to distance measurement is independent of the distance itself, the angular error results in an error, in terms of position, which is greater as distance increases, this error being equal to the product of angular error times distance. In practice, it is as if the angular error is resolved, in terms of position, into a displacement along an arc of a circle and thus into a “dummy” tangential motion.

Substantially, the error on the geometric angle measurement can be likened to a tangential velocity component—which is not actually present—and as such can be filtered out and eliminated.

Thus, filtering is applied that is designed to limit the above “dummy” tangential velocity so that the determined trajectories are closer to the real ones. Substantially, the angle error is corrected by limiting the tangential displacement in the time unit while not acting on the radial velocity.

In detail, we consider having a series of n measurements made on the distance and electrical phase of the signal exchanged between sensor 11 and TAG 10.

Therefore, each measurement is characterized by two parameters, i.e., the measured distance and measured angle of arrival:
dᵢ, αᵢ
   where the index “I” refers to the i-th point in the time sequence of measurements taken, detected at time instant tᵢ by the sensor, on the electromagnetic signal transmitted by the TAG, i.e., in other words, at the i-th measurement of the spatial position of the TAG.

The angle α_{i_s} is the angle relative to the instant “i” once the filtering operation is performed.

For the purposes of the algorithm, we assume that at the initial instant with i=0 the filtered angle coincides with the measured angle.

α_{0_s}=α₀

For each point i≥1, an estimated tangential velocity vₜᵢ is calculated.

For example, the calculation of the above tangential velocity can be made based on the equation:

$${v}_{ti} = ( {α}_{i} - {α}_{i - 1 \_ s} ) {d}_{i}$$

where α_{i-1_s} is the angle obtained from the preceding measurement and subjected to filtering.

The aforesaid filtering makes it possible to therefore calculate a filtered geometric angle, α_{i_s}, based on the calculated value of the tangential velocity, vₜᵢ, and an acceptable maximum value of the tangential velocity, vₜₘₐₓ. For example, the value of said filtered geometric angle can be calculated as follows:

$${α}_{i \_ s} = {α}_{i} \qquad if \vert {v}_{ti} \vert \leq \vert {v}_{tmax} \vert ;$$

$${α}_{i \_ s} = {α}_{i - 1 \_ s} + K \qquad if \vert {v}_{ti} \vert > \vert {v}_{tmax} \vert ;$$

where K can, for example, be defined as follows:

$$K = [ \vert {v}_{tmax} \vert ( {t}_{i} - {t}_{i - 1} ) / {d}_{i} ] sgn ( {v}_{ti} )$$

With the application of this tangential filtering, the movement on the arc centered in the receiver/sensor and passing through the transmitter/TAG is thus limited, thus reducing the noise due to the inaccuracy of the measurement of the angle of arrival. Knowing the position and evolution of the relative position between two objects, such as a moving machine or vehicle and a person moving in the same area, also provides knowledge of the relative velocity between the two objects. Knowing the velocity, together with location, then allows the behavior of detection systems to be made adaptive so that they can provide alarms, which are produced more intelligently than simply detecting that a given distance threshold has been exceeded.

Indeed, the fact that a target is at a given distance may or may not result in a dangerous situation according to whether said target is approaching or moving away. The relative position in terms of the angle between the two potential colliders also influences the actual dangerousness of the detected distance. Indeed, if a TAG is detected in a zone in which the vehicle with which the TAG is associated can not go, it is apparent that in that case, the alarm distance may be shorter.

Therefore, the alarm distance can be dynamically determined rather than kept constant. Thus, the alarm distance can depend on a multiplicity of factors, such as, in addition to distance, relative velocity and angle between the two potential interferers, e.g., according to the relationship:

$$w = {s}_{d} + {d}_{s} + {s}_{int}$$

where w is the adaptive alarm distance, dₛ is the static alarm distance—a constant value relative to the velocity of the TAG, defined as the alarm distance at zero velocity—which, in turn, depends on the relative position and thus on the detected distance and angle of TAG 10 in the sensor reference system 11. The relationship which connects the angle αᵢ and the distance dᵢ to the static distance dₛ can be of various types according to various known geometric formulas.

In a simple but effective case, we can consider dₛ dependent on only αᵢ, for example via a precompiled tabulation of distance values dₛ corresponding to angle values αᵢ. sᵢₙₜ is the space traveled before the system can begin to act or reaction space.

If the system is operated by a human operator, it also comprises the reaction time of a human operator:
sᵢₙₜ=vₘ tᵢₙₜ if vₘ>0
sᵢₙₜ=0 if vₘ≤0
   where tᵢₙₜ is the intervening time and vₘ is the relative velocity between a medium and an operator on a possible collision course with the medium, i.e., between said sensor 11 and said TAG 10.

and Vₘ=(dᵢ−dᵢ₋₁)/(tᵢ−tᵢ₋₁)

Finally, s_{d} is a deceleration space that can be calculated as follows:

s_{d}=(vₘ−v_{safe})²/2a if vₘ>v_{safe}

s_{d}=0 if vₘ≤v_{safe}

where v_{safe} is a velocity which is considered safe but could also be zero in the most conservative case, and a is the deceleration that the vehicle at the machinery can operate for slowing down safely. Thus, in this manner, the alarm activation distance can be changed according to the relative motion between the sensor device 11 and the TAG device 10.

There will then be an alert zone of definable shape based on the layout of the zone of concern and the characteristics of the machinery, operators, and activities associated therewith in the zone of concern. Said area results as a function of the angle αᵢ and will adapt, in terms of effective extent, based on the relative motion conditions vₘ between the TAG(s) and sensor(s) 11.

Furthermore, by knowing the relative velocity between the sensor device 11 and the TAG device 10, other useful parameters can be calculated to measure the hazard level of a given zone. A detected occurrence of the hazardous proximity between mobile machinery and operator (or other mobile or fixed machinery) can indeed be associated with a risk function calculated by considering relative motion. Thus, in this manner, it is possible to associate a proximity occurrence event with significant weight for the assessment of actual risk.

For example, detections can be considered to correspond to the estimates made, in a given area, of the instantaneous distance between potential colliders. These detections all have a time stamp indicating when they occurred. Based on these detections, for example, it is possible to define a detection risk function, rᵢ, which depends on the measured distance, dᵢ, and the adaptive alarm distance, wᵢ:

rᵢ=f(wᵢ,dᵢ)

Again, the “i” index is relative to the i-th conducted detection.

This function can be defined in more than one way but, with wᵢ being equal, it must be monotone decreasing relative to dᵢ.

Examples of function rᵢ can be as follows:

rᵢ=1 if dᵢ≤wᵢ(t);

rᵢ=1/exp(dᵢ−wᵢ) if dᵢ>wᵢ(t);

or the following:

rᵢ=1 if dᵢ≤wᵢ(t);

rᵢ=1/[1+(dᵢ−wᵢ)ⁿ] if dᵢ>wᵢ(t);

where n is any number>0,
or the following:

rᵢ=1 if dᵢ≤wᵢ;

rᵢ=0 if dᵢ≥kwᵢ;

rᵢ=(kwᵢ−dᵢ)/(k−1)wᵢ if wᵢ<d<kwᵢ;

where k>1
or even the following:

rᵢ=1 if dᵢ≤wᵢ;

rᵢ=wᵢ/dᵢ if dᵢ>wᵢ;

Based on the risk function of the above detection, a minimum risk threshold rₘᵢₙ can be defined so that measurements with a risk factor below this threshold are considered irrelevant.

A parameter (said interaction) is then introduced, which represents an event with which a group of detections or measurements is associated. For example, a forklift truck that in its movement transits in close proximity to one or more operators on foot will cause a group of detections/measurements which, although probably different from one another in terms of distance and position detected, can be considered to refer to the same event that is defined as an interaction. In further detail, a set of detections made within a given time interval and such that r>rₘᵢₙ constitutes an interaction.

With each detected interaction we can associate a risk factor of the interaction starting from the risk factors of the individual detections that are part of the interaction:

R=f(r₁,r₂,r₃, . . . rᵢ).

Examples of interaction risk functions may be the following:

R=Max(r₁,r₂,r₃, . . . rᵢ);

R=(Sᵢrᵢ)/N, where N is the number of detections in the interaction.

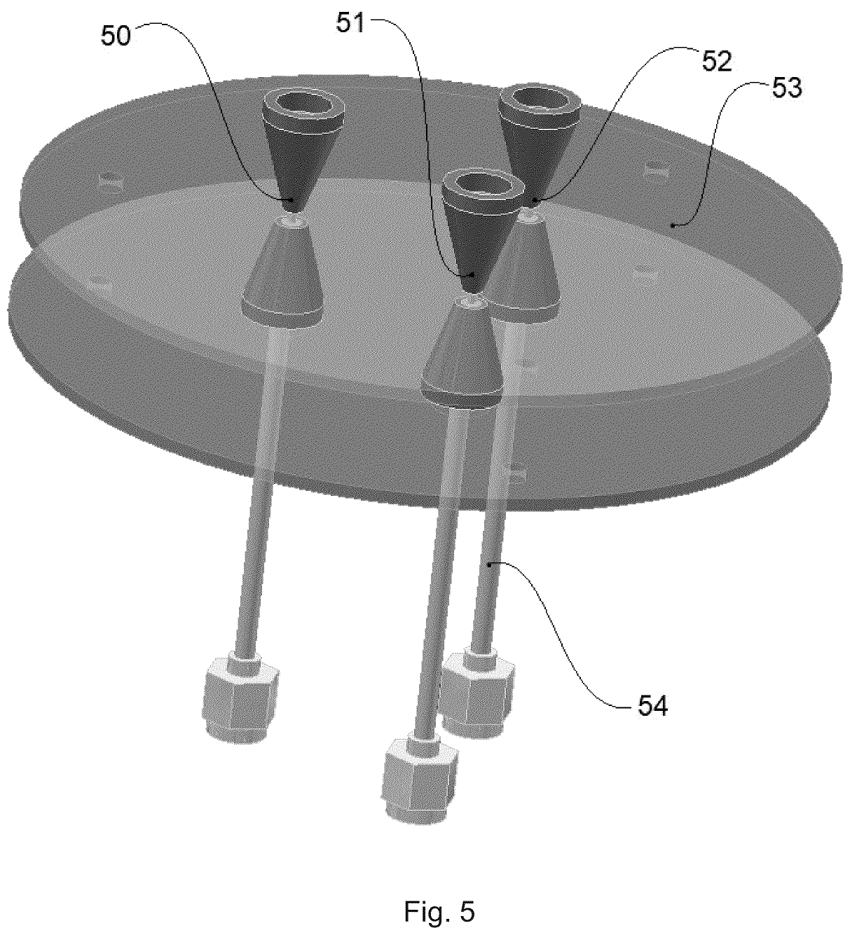

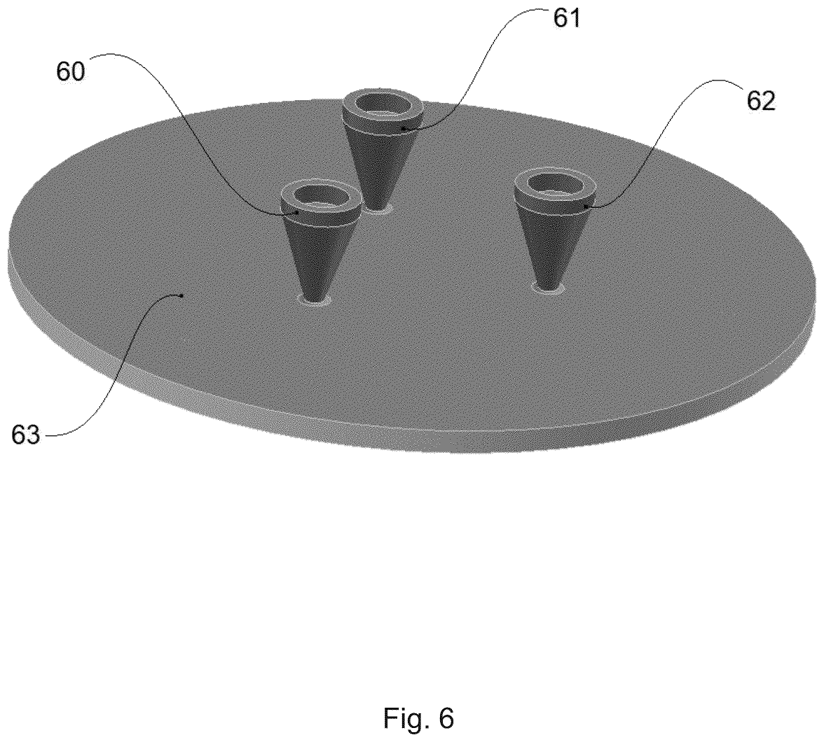

The antennas of said sensor 11 can be of various kinds; however, omnidirectional antennas in the plane and with a sufficiently wide bandwidth for UWB signals or location signals, in general, are preferred. Some preferred embodiments are shown in accompanying FIG. 5 and FIG. 6. FIG. 5 shows a trio of biconical antennas 50, 51, 52, mounted on a base 53 of nonconductive, radio-transparent material. The outer conductor of the power cable 54 is connected to the lower cone while the center pole of the power cable is connected to the upper cone.

FIG. 6 shows a trio of single-conical antennas 60, 61, 62 mounted on a circular ground plane 63. In this case, the cones are connected to the center pole of the power cable while the outer conductor of the power cable is connected to the ground plane.

Both of these embodiments allow excellent bandwidth while maintaining acceptable mutual interference that is manageable with the processing techniques described above.

In both of the above-mentioned preferred embodiments, the cones are made with a hollow interior. This allows for optimal current distribution and thus a similar operation of the antenna-conical or biconical-to the theoretical one and also allows for easy fabrication, simplifying the operations of soldering the center pole from inside the cone.

The inclination of the side surface of the aforementioned cones relative to the axis of the cones themselves is preferably between 20 and 40 degrees with an optimal inclination of about 28 degrees. These values of inclination of the side surface of the cones relative to their axis allow for restrained electromagnetic interaction between the different cones, and thus limited deformation of the electrical phase of the received signal, while maintaining excellent performance in terms of gain and bandwidth.

A possible implementation of the described invention makes an anti-collision system for forklifts. In this case, shown in accompanying FIG. 1, a single sensor installed on the forklift can detect the position of an operator on the ground provided with a TAG transceiver device with remarkable accuracy. The possible embodiments of the described system are virtually unlimited because the sensor and the TAG can be associated with any machinery, fixed or mobile, and any operator present in construction sites, warehouses, and industrial sites in general. The invention makes it possible to detect not only the relative position of two potentially interfering elements but also the relative motion between these elements, thus providing the ability to assess and discriminate potentially dangerous situations with much greater accuracy and efficiency.

1. A radio-frequency system comprising a first transceiver device or TAG device and at least one second transceiver device or sensor device, wherein said sensor device and said TAG device are tuned to the same operational radio frequencies and are adapted to transmit and receive data through a radio-frequency link, wherein said TAG comprises:
at least one radio-frequency transceiver,
at least one antenna associated with said transceiver, and
a controller configured to drive said transceiver appropriately to manage its transmission and reception sequences, and wherein said sensor comprises:
at least three radio-frequency transceivers,
at least three omnidirectional antennas on a plane normal to their axis and each associated with said at least three radio-frequency transceivers,
a control unit, configured to drive said transceivers and an external interface and configured to process the signals received from said TAG so as to determine the distance d of said TAG from said sensor and the electrical phase θ of the signals received on each of said antennas and further configured to calculate the geometric angle α for approaching the TAG to the sensor by processing the electrical phase θ of the signals received by said at least three antennas.

2. A The system according to claim 1, wherein the radio-frequency link between said sensor and said TAG is of the Ultra-Wide Band (UWB) type.

3. The system according to claim 1, wherein said control unit is adapted to determine said distance, d by calculating the time-of-flight of the signal between said TAG and said sensor.

4. The system according to claim 1, wherein said sensor is configured to measure the distance, d of said TAG with respect to said sensor by means of Round Trip Time (RTT) techniques or Two Way Ranging (TWR) techniques.

5. The system according to claim 1, wherein said operational radio-frequencies are comprised between 2 GHz and 10 GHz.

6. The system according to claim 1, wherein said at least three antennas have a mutual distance comprised between one-half and one-fourth of the wavelength of the transmitted and received electromagnetic signal.

7. The system according to claim 1, wherein said mutual distance is approximately equal to ⅖ of the wavelength of the transmitted and received electromagnetic signal.

8. The system according to claim 1, wherein said sensor is further configured to correct the calculated value of the geometric angle α for approaching the TAG to the sensor by means of a table which links geometric angles values α to electrical phase values θ of the electromagnetic signals received by said at least three antennas in the initial step of tuning.

9. The system according to claim 1, wherein the antennas of said sensor are mono-conical antennas and mounted on a circular ground plane.

10. The system according to one or more of the preceding claims, wherein the antennas of said sensor are bi-conical antennas mounted on a base plate of non-conductive, radio-transparent material.

11. A method for detecting the distance d and the arrival angle α of a first transceiver device or TAG with respect to a second transceiver device or sensor of the radio-frequency system according to one or more of claims 1 to 9, comprising:
receiving a signal transmitted by said TAG by each of the antennas of said sensor;
determining the electrical phase θ of the signals received by each of the antennas;
determining the distance d by calculating the time of flight of the signal between said TAG and said sensor;
calculating the geometric angle α for approaching the TAG to the sensor by processing the electrical phase θ of the signals received on said antennas.

12. The method according to claim 11, wherein the calculated value of the geometric angle α for approaching the TAG to the sensor is corrected by using a table linking the geometric angles values αₖ to electrical phase values θ₁ₖ, θ₂ₖ of the electromagnetic signals received on said antennas during the initial step of tuning.

13. The method according to claim 11, wherein the calculated value of the geometric angle α for approaching the TAG to the sensor is corrected by filtering the tangential components of said geometric angle α.

14. The method according to claim 13, wherein said filtering of tangential components of said geometric angle α comprises:
for each of said measured value of said geometric angle αᵢ and distance dᵢ, calculating a corresponding tangential velocity equal to vₜᵢ=(αᵢ−α_{i-1_s}) dᵢ, wherein α_{i-1_s} is the value of said geometric angle calculated above and filtered;
calculating the value of said filtered geometric angle α_{i_s} based on the calculated value of the tangential velocity vₜᵢ and on a predetermined maximum value of said tangential velocity vₜₘₐₓ. so that vₜᵢ, ≤vₜₘₐₓ.

15. The method according to claim 14, wherein the value of said filtered geometric angle α_{i_s} is equal to αᵢ if |vₜᵢ|≤|vₜₘₐₓ| and is equal to α_{i-1_s}+K if |vₜᵢ|>|vₜₘₐₓ|, where K=[|vₜₘₐₓ|(tᵢ−tᵢ₋₁)/dᵢ]sgn(vₜᵢ).

16. The method according to claim 11 comprising:
calculating an adaptive alarm distance between said TAG and said sensor, w=s_{d}+dₛ+sᵢₙₜ, wherein dₛ is a static alarm distance, sᵢₙₜ is a reaction space and s_{d} is a deceleration space.

17. The method according to claim 16, wherein the value of said static alarm distance dₛ is determined as a function of said geometric angle α and the distance d of said TAG from said sensor

18. The method according to claim 16 comprising:
calculating a risk level of detection r, a monotonic decreasing function of the distance d of said TAG with respect to said sensor and of the adaptive alarm distance w.

19. The method according to claim 18 comprising:
selecting the risk level values above a given minimum risk threshold rₘᵢₙ so that rᵢ>rₘᵢₙ;
calculating a risk factor of interaction R, function of said risk level values so that rᵢ>rₘᵢₙ;

20. The method according to claim 19, wherein R=Max(r₁, r₂, r₃, . . . rᵢ) or R=(Sᵢrᵢ)/N, wherein N is the total number of detections made.
